(19) United States
(12) Patent Application Publication
(10) Pub. No.: US 2025/0135995 A1
(43) Pub. Date: May 1, 2025

(54) NOTIFICATION SYSTEMS AND METHODS FOR A VEHICLE CONTROLLED BY AN EXTERNAL INTERFACE

(71) Applicant: Ford Global Technologies, LLC, Dearborn, MI (US)

(72) Inventors: David Hancock, South Rockwood, MI (US); Scott Steadmon Thompson, Belleville, MI (US); John Eric Rollinger, Troy, MI (US); Pietro Buttolo, Dearborn Heights, MI (US); Matthew Ryan Preston, Whitmore Lake, MI (US); Joseph Dorigo, Plymouth, MI (US)

(21) Appl. No.: 18/500,012

(22) Filed: Nov. 1, 2023

(51) Int. Cl. B60Q 9/00; G05D 1/00; G05D 1/02; G06V 20/58

(52) U.S. Cl. CPC B60Q 9/008; G06V 20/58; B60Q 2800/10

(57) ABSTRACT

A vehicle including a transceiver and a processor is disclosed. The transceiver may be configured to receive a request to activate an external interface movement mode associated with the vehicle to enable a vehicle movement control via an external interface. The external interface may be configured to be removably attached to a vehicle exterior surface. The processor may be configured to obtain the request from the transceiver and determine that a predefined condition may be met responsive to obtaining the request. The processor may be further configured to activate the external interface movement mode responsive to determining that the predefined condition may be met. In addition, the processor may output a notification via a vehicle exterior light and/or a vehicle speaker responsive to activating the external interface movement mode.

### FIELD

The present disclosure relates to a notification system and method for a vehicle controlled by an external interface configured to be removably attached to a vehicle exterior surface.

### BACKGROUND

Users may move their vehicles over relatively short distances frequently when the users may be performing outdoor activities or tasks. For example, a user may frequently move the user's vehicle over short distances (e.g., 5-10 meters) as the user performs the activity.

It may be inconvenient for the user to frequently enter and move the vehicle and then exit the vehicle multiple times to perform the activity, and hence the user may not prefer to enter the vehicle frequently when the user may be performing such activities. Therefore, it may be desirable to have a system that may enable the user to conveniently move the vehicle over relatively short distances without repeatedly entering and exiting the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to output a notification from a vehicle in accordance with the present disclosure.

FIG. 3 depicts a top view of a vehicle in accordance with the present disclosure.

FIG. 4 depicts a light illumination pattern output from a vehicle exterior light in accordance with the present disclosure.

FIG. 5 depicts patterns of audio notifications output from one or more vehicle speakers in accordance with the present disclosure.

FIG. 6 depicts a flow diagram of a notification method in accordance with the present disclosure.

### DETAILED DESCRIPTION

### Overview

The present disclosure describes a vehicle that may be moved by using an external interface that may be removably attached to a vehicle exterior surface. A user may cause vehicle movement and/or vehicle steering wheel rotation by providing user inputs to the interface, which may transmit the user inputs via a wired connection or a wireless network to the vehicle to cause the vehicle movement and/or the vehicle steering wheel rotation. In some aspects, the user may transmit, via a user device or a vehicle Human-Machine Interface (HMI), a request to the vehicle to enable an external interface movement mode associated with the vehicle to cause and/or control the vehicle movement via the interface. Responsive to receiving the request, the vehicle may authenticate the user, determine that the user may be located within a predefined distance from the vehicle and/or authenticate the interface. The vehicle may then activate the external interface movement mode when the user and/or the interface may be authenticated, and/or the user may be located within the predefined distance from the vehicle. The user may start to cause and/or control the vehicle movement via the interface when the external interface movement mode may be activated.

In some aspects, responsive to activating the external interface movement mode, the vehicle may output one or more notifications via vehicle exterior lights and/or vehicle speakers to notify/alert bystanders who may be located in proximity to the vehicle about the external interface movement mode activation. The notifications may indicate to the bystanders that the external interface movement mode associated with the vehicle may be activated, and hence the vehicle may move via the interface. In further aspects, when the user may be causing and/or controlling the vehicle movement via the interface, the vehicle may output additional notifications indicative of a vehicle speed, a vehicle movement direction, a vehicle steering wheel rotation angle, and/or the like, to assist the bystanders in knowing about the vehicle movement. In some aspects, the vehicle may output the notifications described above in different visual and/or audible patterns via the vehicle exterior lights and/or the vehicle speakers, so that the bystanders may conveniently know about the different vehicle movements.

In additional aspects, the vehicle may output, via the vehicle exterior lights and/or the vehicle speakers, one or more additional notifications to notify/inform the user about an obstacle that may be present in proximity to the vehicle, a faulty interface condition, and/or when an external equipment/tool may be attached to a vehicle power socket via a wired connection. In some aspects, the vehicle may disable (or not enable) the external interface movement mode when the vehicle determines that the external equipment/tool may be attached to the vehicle power socket via the wired connection. The vehicle may enable (or re-enable) the external interface movement mode only when the external equipment/tool may be removed or detached from the vehicle power socket.

The present disclosure discloses a vehicle that may be moved by providing inputs to an interface that may be removably attached to a vehicle exterior surface. The interface may enable the user to cause the vehicle movement without having to enter the vehicle interior portion. Since the user is not required to enter the vehicle to cause the vehicle movement, the interface may facilitate the user in performing outdoor activities such as farming, laying fences, etc., which may require frequent vehicle movement over short distances. Further, the vehicle may output notifications to alert/inform bystanders and the user about vehicle's movement status, interface status, and/or the like, which may enhance convenience of the bystanders and the user.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

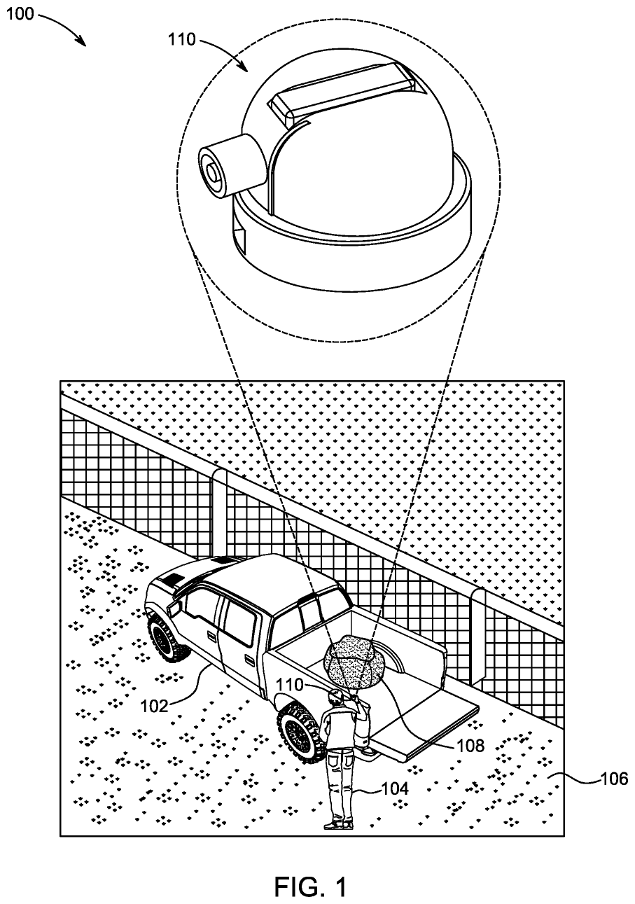

FIG. 1 depicts an example environment 100 in which techniques and structures for providing the systems and methods disclosed herein may be implemented. The environment 100 may include a vehicle 102 and a user 104. The user 104 may be performing an outdoor activity in a farm 106 where the vehicle 102 may be located. For example, the user 104 may be sowing plants on a farm periphery or may be laying fences. The user 104 may be using vehicle cargo bed to store material 108 that may be required to perform the outdoor activity, e.g., sand, plants, equipment/tools, manure, and/or the like. In some aspects, the user 104 may be required to move the vehicle 102 frequently over short distances (e.g., 5-10 meters) as the user 104 performs the outdoor activity around the farm periphery.

The vehicle 102 may take the form of any passenger or commercial vehicle such as, for example, a car, a work vehicle, a crossover vehicle, a van, a minivan, etc. Further, the vehicle 102 may be a manually driven vehicle and/or may be configured to operate in a fully autonomous (e.g., driverless) mode or a partially autonomous mode and may include any powertrain such as, for example, a gasoline engine, one or more electrically-actuated motor(s), a hybrid system, etc.

The environment 100 may further include an external interface 110 (or interface 110) that may be configured to be removably attached to a vehicle exterior surface (or a vehicle interior surface). In some aspects, the vehicle exterior surface may include one or more cavities or slots or connection ports into which the user 104 may insert/attach or “plug-in” the interface 110. As an example, the connection ports may be disposed on a top surface of vehicle side walls, on right and left edges of a vehicle bumper, a vehicle cargo bed, and/or the like. In the exemplary aspect depicted in FIG. 1, the interface 110 is attached to the top surface of a vehicle side wall, although the present disclosure is not limited to such an aspect.

The interface 110 may be configured to cause and/or control vehicle movement based on user inputs. In some aspects, the user 104 may not be required enter and exit the vehicle 102 multiple times to frequently move the vehicle 102 over the short distances around the farm periphery by using the interface 110. Since the interface 110 may be configured to be removably attached to the vehicle exterior surface, the user 104 may conveniently cause and control the vehicle movement from outside the vehicle 102 by using the interface 110.

In some aspects, the interface 110 may be configured to cause and/or control the vehicle movement when the interface 110 may be attached to one of the connection ports described above. In other aspects, the interface 110 may be configured to cause and/or control the vehicle movement by transmitting command signals wirelessly to the vehicle 102 when the interface 110 may be disposed within a predefined distance from the vehicle 102.

In some aspects, the interface 110 may be dome-shaped (as shown in FIG. 1) and may include a user input detection unit (not shown) including, but not limited to, pressure sensors, a spring-loaded rotary position sensing element, and/or the like, which may detect user inputs associated with desired vehicle movement when the user 104 interacts with the interface 110. As an example, the user 104 may provide a “forward push” to the interface 110 when the user 104 desires the vehicle 102 to move forward. The forward push may be detected by the pressure sensors included in the user input detection unit, and the pressure sensors may then generate electric current/command signals that may be transmitted, e.g., via a wired connection or a wireless network, to the vehicle 102 to cause vehicle forward movement. Similarly, the user 104 may provide a “backward push” to the interface 110 when the user 104 desires the vehicle 102 to move in a reverse direction. Furthermore, the user 104 may rotate the interface 110 in a clockwise or counterclockwise direction when the user 104 desires a vehicle steering wheel to rotate right or left. In this case, the spring-loaded rotary position sensing element may generate the command signals that may enable the vehicle 102 to cause the vehicle steering wheel to rotate right or left.

In other aspects, the interface 110 may have a shape of an elongated rod or stick and may act like a joystick having one or more tilt and/or pressure and/or displacement sensors, torsional motion sensors, and/or the like. In yet another aspect, the interface 110 may include a plurality of switches or buttons on a switchboard, which may be removably attached to the vehicle 102 or may be hand-held. Although FIG. 1 depicts the interface 110 to be dome-shaped, such depiction should not be construed as limiting, and the interface 110 may have any other shape as described above. Specifically, the dome-shaped interface depicted in FIG. 1 is just for illustrative purpose, and the methods and systems described in the present disclosure may operate equally efficiently with any other type of interface that performs similar functions as the interface 110.

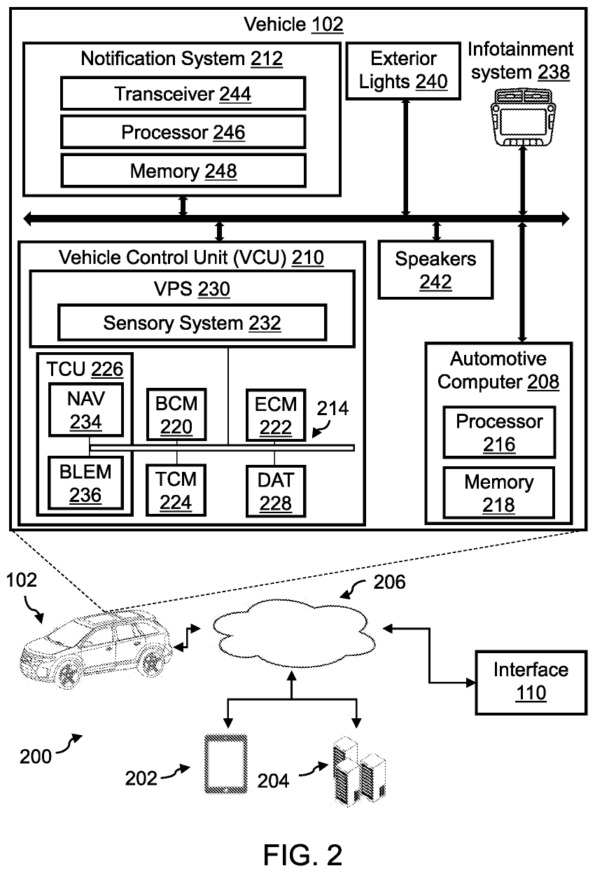

In some aspects, to cause and/or control the vehicle movement using the interface 110, the user 104 may first activate an external interface movement mode associated with the vehicle 102. For example, the user 104 may transmit a request to the vehicle 102 to activate the external interface movement mode when the user 104 desires to cause and/or control the vehicle movement using the interface 110. The user 104 may transmit the request via a user device (shown as user device 202 in FIG. 2) or a vehicle Human-Machine Interface (HMI) or vehicle infotainment system (shown as infotainment system 238 in FIG. 2). Responsive to receiving the request, the vehicle 102 may authenticate the user 104, determine whether the user 104 may be in proximity to the vehicle 102 and/or authenticate the interface 110 (e.g., to determine that the interface 110 is an authentic interface associated with the vehicle 102), before enabling the user 104 to cause and/or control the vehicle movement using the interface 110.

In some aspects, the vehicle 102 may authenticate the user 104 by requesting the user 104 to input a preset passcode/password on the infotainment system or the user device, by authenticating the user device (e.g., when the user device may be executing a phone-as-a-key (PaaK) application and communicatively paired with the vehicle 102), and/or by authenticating/pairing with a key fob (not shown) associated with the vehicle 102 that the user 104 may be carrying. The methods described here for authenticating the user 104 are exemplary in nature and should not be construed as limiting. The vehicle 102 may authenticate the user 104 by any other method (e.g., facial recognition, fingerprint recognition, etc.) as well, without departing from the present disclosure scope.

The vehicle 102 may determine that the user 104 may be in proximity to the vehicle 102 by determining a user device location (when the user device may be executing the PaaK application and communicatively paired with the vehicle 102) or a key fob location. When the user device may not be executing the PaaK application, the vehicle 102 may determine the user device location by determining received signal strength indicator (RSSI) value associated with the user device. In other aspects, the vehicle 102 may determine that the user 104 may be in proximity to the vehicle 102 by obtaining user images from vehicle cameras and/or inputs from other vehicle sensors (e.g., radio detecting and ranging (radar) sensors). The methods described here for determining that the user 104 may be in proximity to the vehicle 102 are exemplary in nature and should not be construed as limiting. The vehicle 102 may determine user location by any other method as well, without departing from the present disclosure scope.

The vehicle 102 may authenticate the interface 110 by exchanging preset authentication codes with the interface 110, when the interface 110 may be communicatively coupled with the vehicle 102 via a wireless network and/or when the interface 110 may be attached to the vehicle exterior surface via a connection port described above. The preset authentication codes may be pre-stored in the vehicle 102 and the interface 110 when, for example, the interface 110 may be first registered with the vehicle 102 (e.g., when the interface 110 may be first used with the vehicle 102). In other aspects, in addition to or alternative to exchanging the preset authentication codes, the vehicle 102 and the interface 110 may obtain an encryption key from an external server (shown as server 204 in FIG. 2) when the interface 110 may be communicatively coupled with the vehicle 102 and/or when the interface 110 may be attached to a connection port. In this case, the vehicle 102 may authenticate the interface 110 by obtaining the encryption key from the interface 110 and matching it with the encryption key that the vehicle 102 may have obtained from the external server. In some aspects, a new encryption key may be generated and transmitted by the external server to the vehicle 102 and the interface 110 each time the interface 110 may be coupled/attached with the vehicle 102.

When the vehicle 102 authenticates the user 104 and/or the interface 110, and/or determines that the user 104 may be located within a predefined distance from the vehicle 102, the vehicle 102 may determine that a predefined condition may be met and may then enable the interface 110 to cause and/or control the vehicle movement based on the user inputs received at the interface 110. Stated another way, in this case, the vehicle 102 may activate the external interface movement mode associated with the vehicle 102 when the vehicle 102 determines that the predefined condition may be met.

When the vehicle 102 activates the external interface movement mode, the user 104 may cause and/or control the vehicle movement by using the interface 110. For example, the user 104 may provide inputs to the interface 110 to cause vehicle forward or reverse movement, change vehicle speed and/or rotate vehicle steering wheel clockwise or counterclockwise.

In some aspects, the vehicle 102 may output one or more notifications to notify/alert bystanders/passersby in proximity to the vehicle 102 that the vehicle 102 may have activated the external interface movement mode and hence the vehicle 102 may move and/or get controlled by the interface 110. The vehicle 102 may further output notifications indicative of the vehicle speed, a rate of change of vehicle speed, a vehicle movement direction, a vehicle steering wheel rotation angle, and/or the like, when the user 104 may be causing and/or controlling the vehicle movement via the interface 110.

In further aspects, the vehicle 102 may output notifications when the interface 110 may be faulty or may be connected in an improper manner to the vehicle exterior surface. Such notifications may assist the user 104 in optimally using the interface 110 and/or getting the interface 110 repaired when the interface 110 may be faulty. The vehicle 102 may additionally output notifications when an obstacle (e.g., a passerby) may be present in proximity to the vehicle 102 when the user 104 may be causing and/or controlling the vehicle movement using the interface 110, or when the vehicle 102 may be moving/travelling on a surface that may be rough, slippery or inclined at an angle greater than a predefined inclination angle threshold.

In additional aspects, the vehicle 102 may implement restrictions on the vehicle speed and/or the vehicle steering wheel rotation angle when the vehicle 102 detects that the obstacle may be present in proximity to the vehicle 102 when the user 104 may be causing and/or controlling the vehicle movement using the interface 110 and/or when the surface may be rough, slippery or inclined. For example, the vehicle 102 may not enable the vehicle speed (as controlled by the interface 110) to increase greater than or beyond a maximum permissible vehicle speed when the obstacle may be detected. Similarly, the vehicle 102 may not enable the vehicle speed to increase greater than the maximum permissible vehicle speed when the surface may be slippery.

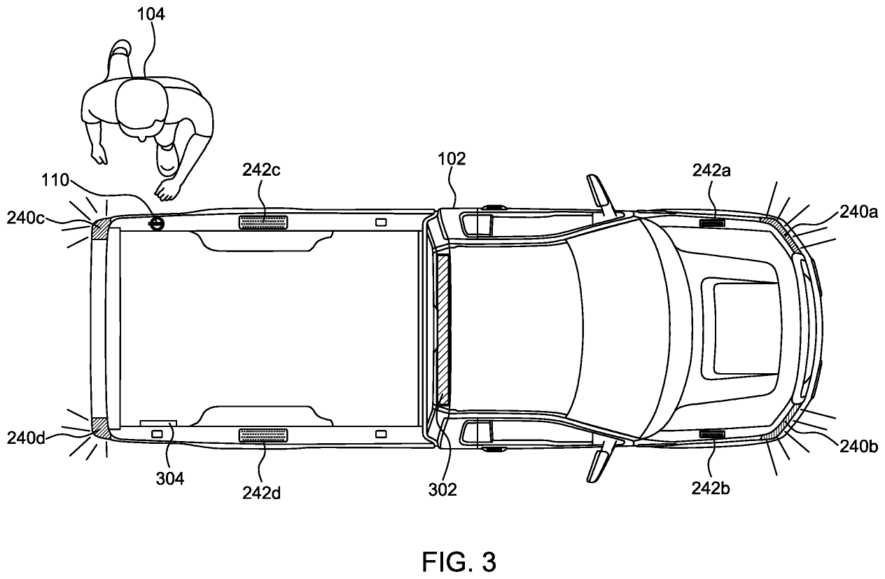

Furthermore, the vehicle 102 may be configured to disable the external interface movement mode or not activate the external interface movement mode when the vehicle 102 determines that one or more external equipment/tools may be connected with or plugged into a vehicle power transfer interface/power socket (shown as power transfer interface 304 in FIG. 3) via a wired connection. In this case, the vehicle 102 may additionally output a notification requesting the user 104 to disconnect the external equipment/tools from the vehicle power transfer interface before the external interface movement mode may be activated and the user 104 may be allowed to cause/control the vehicle movement using the interface 110.

In some aspects, the vehicle 102 may include one or more vehicle exterior lights (shown as exterior lights 240 in FIG. 2) and one or more vehicle speakers (shown as speakers 242 in FIG. 2). The vehicle 102 may output the different notifications described above by illuminating one or more vehicle exterior lights in different patterns and/or by outputting the different notifications audibly in different patterns or different volumes via one or more vehicle speakers. The process of outputting the notifications is described in detail later below in conjunction with FIG. 2.

The vehicle 102 and the interface 110 implement and/or perform operations, as described here in the present disclosure, in accordance with the owner manual and safety guidelines. In addition, any action taken by the user 104 based on recommendations or notifications provided by the vehicle 102 should comply with all the rules specific to the location and operation of the vehicle 102 (e.g., Federal, state, country, city, etc.). The recommendation or notifications, as provided by the vehicle 102, should be treated as suggestions and only followed according to any rules specific to the location and operation of the vehicle 102.

FIG. 2 depicts a block diagram of a system 200 to output a notification from the vehicle 102 in accordance with the present disclosure. While describing FIG. 2, references will be made to FIGS. 3, 4 and 5.

The system 200 may include the vehicle 102, the interface 110, a user device 202, and one or more servers 204 (or server 204) communicatively coupled with each other via one or more networks 206 (or a network 206). In some aspects, the vehicle 102 and the interface 110 may be communicatively coupled with each other via the network 206 as shown in FIG. 2, or via a wired connection.

The user device 202 may be associated with the user 104 and may be, for example, a mobile phone, a laptop, a computer, a tablet, a wearable device, or any other similar device with communication capabilities. The server 204 may be part of a cloud-based computing infrastructure and may be associated with and/or include a Telematics Service Delivery Network (SDN) that provides digital data services to the vehicle 102 and other vehicles (not shown) that may be part of a vehicle fleet. In further aspects, the server 204 may be configured to provide encryption keys to the vehicle 102 and the interface 110 to enable interface authentication, when the user 104 transmits, e.g., via the user device 202, the request to the vehicle 102 to activate the external interface movement mode, as described above in conjunction with FIG. 1.

The network 206 illustrates an example communication infrastructure in which the connected devices discussed in various embodiments of this disclosure may communicate. The network 206 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The interface 110 may include a plurality of interface sensors (not shown) including, but not limited to, pressure sensors, capacitive sensors, rotary position sensing element, an interface accelerometer, an interface gyroscope, an interface magnetometer, and/or the like. The interface 110 may be configured to determine/detect, via one or more interface sensors described above, user inputs associated with vehicle longitudinal movement (e.g., vehicle forward or reverse movement) and/or vehicle steering wheel rotation on the interface 110 and generate command signals based on the user inputs. The interface 110 may transmit the generated command signals to the vehicle 102 (via the network 206 or a wired connection) to enable the vehicle movement based on the user inputs (e.g., when the vehicle 102 enables the interface 110 to cause and/or control the vehicle movement).

The vehicle 102 may include a plurality of units including, but not limited to, an automotive computer 208, a Vehicle Control Unit (VCU) 210, and a notification system 212 (or system 212). The VCU 210 may include a plurality of Electronic Control Units (ECUs) 214 disposed in communication with the automotive computer 208.

In some aspects, the user device 202 may be configured to connect with the automotive computer 208 and/or the system 212 via the network 206, which may communicate via one or more wireless connection(s), and/or may connect with the vehicle 102 directly by using near field communication (NFC) protocols, Bluetooth® protocols, Wi-Fi, Ultra-Wide Band (UWB), and other possible data connection and sharing techniques.

The automotive computer 208 and/or the system 212 may be installed anywhere in the vehicle 102, in accordance with the disclosure. Further, the automotive computer 208 may operate as a functional part of the system 212. The automotive computer 208 may be or include an electronic vehicle controller, having one or more processor(s) 216 and a memory 218. Moreover, the system 212 may be separate from the automotive computer 208 (as shown in FIG. 2) or may be integrated as part of the automotive computer 208.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable storage medium or memory storing a notification program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle systems, connected servers (e.g., the server 204), and other vehicles (not shown in FIG. 2) operating as part of a vehicle fleet. The VCU 210 may include or communicate with any combination of the ECUs 214, such as, for example, a Body Control Module (BCM) 220, an Engine Control Module (ECM) 222, a Transmission Control Module (TCM) 224, a telematics control unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232 (or a vehicle sensor unit). The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“lidar”) sensor, door sensors, proximity sensors, temperature sensors, wheel sensors, one or more ambient weather or temperature sensors, vehicle interior and exterior cameras, steering wheel sensors, a vehicle accelerometer, a vehicle gyroscope, a vehicle magnetometer, ultrasound sensors, etc. The vehicle sensory system 232 may be configured to capture images or videos, via the vehicle exterior cameras, of a geographical area in proximity to the vehicle 102. The vehicle sensory system 232 may be further configured to detect an obstacle presence (e.g., presence of a bystander/passerby) in proximity to the vehicle 102, for example, by using inputs obtained from the vehicle exterior cameras, radar sensor, lidar sensor, and/or the like.

In some aspects, the VCU 210 may control vehicle operational aspects and implement one or more instruction sets received from the server 204, from one or more instruction sets stored in the memory 218, including instructions operational as part of the system 212.

The TCU 226 may be configured and/or programmed to provide vehicle connectivity to wireless computing systems onboard and off board the vehicle 102 and may include a Navigation (NAV) receiver 234 for receiving and processing a GPS signal, a BLE® Module (BLEM) 236, a Wi-Fi transceiver, an ultra-wideband (UWB) transceiver, and/or other wireless transceivers (not shown in FIG. 2) that may be configurable for wireless communication (including cellular communication) between the vehicle 102 and other systems (e.g., a vehicle key fob, not shown in FIG. 2, the server 204, the user device 202, the interface 110, etc.), computers, and modules. The TCU 226 may be disposed in communication with the ECUs 214 by way of a bus.

The ECUs 214 may control aspects of vehicle operation and communication using inputs from human drivers, inputs from the automotive computer 208, the system 212, and/or via wireless signal inputs/command signals received via the wireless connection(s) from other connected devices, such as the server 204, the user device 202, the interface 110, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2). In some aspects, the BCM 220 may be configured to cause the vehicle movement and the vehicle steering wheel rotation based on the command signals (or the user inputs) obtained from the interface 110.

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion.

The computing system architecture of the automotive computer 208, the VCU 210, and/or the system 212 may omit certain computing modules. It should be readily understood that the computing environment depicted in FIG. 2 is an example of a possible implementation according to the present disclosure, and thus, it should not be considered as limiting or exclusive.

The vehicle 102 may further include a plurality of exterior lights 240 and a plurality of speakers 242 that may be disposed in the vehicle exterior portion/surface. For example, as shown in FIG. 3, the vehicle 102 may include a forward left light 240a, a forward right light 240b, a rear left light 240c and a rear right light 240d (collectively referred to as the plurality of exterior lights 240). Similarly, as shown in FIG. 3, the vehicle 102 may include a forward left exterior speaker 242a, a forward right exterior speaker 242b, a rear left exterior speaker 242c and a rear right exterior speaker 242d (collectively referred to as the plurality of speakers 242).

In accordance with some aspects, the system 212 may be integrated with and/or executed as part of the ECUs 214. The system 212, regardless of whether it is integrated with the automotive computer 208 or the ECUs 214, or whether it operates as an independent computing system in the vehicle 102, may include a transceiver 244, a processor 246, and a computer-readable memory 248.

The transceiver 244 may be configured to receive information/inputs from one or more external devices or systems, e.g., the user device 202, the server 204, the interface 110, and/or the like, via the network 206. Further, the transceiver 244 may transmit notifications, requests, signals, etc. to the external devices or systems. In addition, the transceiver 244 may be configured to receive information/inputs from vehicle components such as the VCU 210. Further, the transceiver 244 may transmit signals (e.g., command signals) or notifications to the vehicle components such as the BCM 220, the infotainment system 238, and/or the like.

The processor 246 and the memory 248 may be same as or similar to the processor 216 and the memory 218, respectively. In some aspects, the processor 246 may utilize the memory 248 to store programs in code and/or to store data for performing aspects in accordance with the disclosure. The memory 248 may be a non-transitory computer-readable storage medium or memory storing the notification program code.

In operation, when the user 104 desires to cause and/or control the vehicle movement using the interface 110, the user 104 may transmit, via the user device 202 or the infotainment system 238, a request to the transceiver 244 to activate the external interface movement mode associated with the vehicle 102, as described above in conjunction with FIG. 1. Stated another way, the transceiver 244 may receive the request from the user 104 (via the user device 202 or the infotainment system 238) to activate the external interface movement mode associated with the vehicle 102 to enable a vehicle movement control via the interface 110. The transceiver 244 may transmit the request to the processor 246.

The processor 246 may obtain the request from the transceiver 244. Responsive to obtaining the request, the processor 246 may authenticate the user 104, determine a user location in proximity to the vehicle 102 and/or authenticate the interface 110, as described above in conjunction with FIG. 1. Example methods that may be executed by the processor 246 to authenticate the user 104, determine the user location in proximity to the vehicle 102 and/or authenticate the interface 110 are described above in conjunction with FIG. 1. In some aspects, the processor 246 may determine that a predefined condition may be met when the user 104 may be authenticated, the user location may be located within a predefined distance (e.g., 0-8 feet) from the vehicle 102 and/or the interface 110 may be authenticated.

Responsive to determining that the predefined condition may be met, the processor 246 may activate the external interface movement mode associated with the vehicle 102. Stated another way, responsive to determining that the predefined condition may be met, the processor 246 may enable the user 104 to cause and/or control the vehicle movement via the interface 110. When the external interface movement mode may be activated, the user 104 may begin to provide user inputs on the interface 110 (e.g., provide a forward or reverse push on the interface 110 and/or rotate the interface 110 left or right) to cause and/or control the vehicle movement. Responsive to receiving the user inputs, the interface 110 may transmit, via a wired connection or via the network 206, command signals associated with the user inputs received on the interface 110 to the transceiver 244. The processor 246 may obtain the command signals from the transceiver 244 and cause (via the BCM 220) the vehicle movement and/or control a vehicle movement direction (e.g., vehicle forward or reverse movement), a vehicle speed and/or a vehicle steering wheel rotation angle based on the obtained command signals.

In further aspects, responsive to activating the external interface movement mode associated with the vehicle 102, the processor 246 may output a first notification via one or more exterior lights, from the plurality of exterior lights 240, and/or one or more speakers, from the plurality of speakers 242, to alert bystanders or passersby in proximity to the vehicle 102. The first notification may indicate to the bystanders that the external interface movement mode associated with the vehicle 102 may have been activated, and hence the vehicle 102 may move based on the command signals obtained from the interface 110.

In some aspects, the processor 246 may output the first notification by illuminating one or more exterior lights or all the exterior lights 240 in a first predefined pattern. For example, one or more or all the exterior lights 240a, 204b, 204c and 240d may flash at a first predefined frequency to alert the bystanders. In some aspects, one or more exterior lights may also illuminate in multicolor and/or include a display screen that may display multicolor images when these exterior lights output the first notification.

Further, when the user 104 begins to cause and/or control the vehicle movement by using the interface 110 (responsive to the processor 246 activating the external interface movement mode, as described above), the processor 246 may output a second notification indicative of a vehicle speed, a third notification indicative of a vehicle steering wheel rotation angle, and a fourth notification indicative of a vehicle movement direction, via one or more exterior lights and/or one or more speakers. Similar to the first notification, the second, the third and the fourth notifications may also alert/inform the bystanders about the moving vehicle 102 and its expected speed and/or movement direction.

In some aspects, the processor 246 may output the second notification by illuminating one or more exterior lights or all the exterior lights 240 in a second predefined pattern. For example, the processor 246 may increase or decrease the “frequency of flashing” of the exterior lights based on the vehicle speed. In an exemplary aspect, the exterior lights may flash at a greater frequency (e.g., greater than the first predefined frequency) when the user 104 may be increasing the vehicle speed via the interface 110, and the exterior lights may flash at a lower frequency (e.g., lower than the first predefined frequency) when the user 104 may be decreasing the vehicle speed via the interface 110.

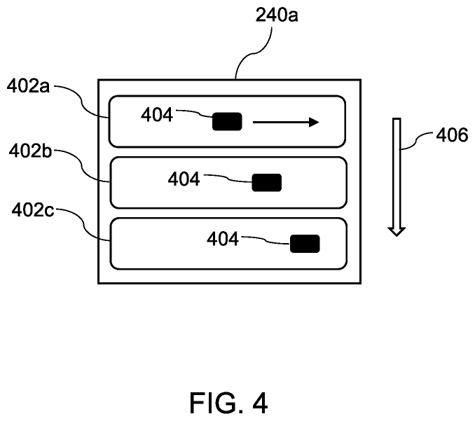

The processor 246 may output the third notification by illuminating one or more exterior lights or all the exterior lights 240 in a third predefined pattern. For example, the processor 246 may cause one or more exterior lights to illuminate light emitting diodes (LEDs) or other lighting elements included in the exterior lights in a “shifting” pattern, indicative of the vehicle steering wheel rotation angle and a vehicle steering wheel rotation speed. For example, as shown in FIG. 4, the forward left light 240a (or any other exterior light from the plurality of exterior lights 240) may include one or more light panels 402a, 402b, 402c that may flash/display a moving light 404 in the direction of the vehicle steering wheel rotation to output the third notification. Further, a frequency of light flashing and/or speed of movement of the moving light 404 may correspond to the vehicle steering wheel rotation speed. In further aspects, length, thickness, and/or other dimensional parameters associated with the moving light 404 may correspond to the vehicle steering wheel rotation angle and/or the vehicle steering wheel rotation speed.

The processor 246 may output the fourth notification by illuminating one or more exterior lights or all the exterior lights 240 in a fourth predefined pattern. For example, as shown in FIG. 4, the light panels 402a, 402b, 402c may illuminate the moving light 404 in a sequence from the light panel 402a to 402b to 402c (as shown by an arrow 406), or in the reverse direction, based on the vehicle movement direction (e.g., based on whether the vehicle 102 may be moving forward or in the reverse direction, as shown in FIG. 4) to output the fourth notification. In some aspects, a speed associated with the shifting of the moving light 404 in the sequence from the light panel 402a to 402b to 402c (or vice-versa) may be indicative of the vehicle speed in the forward or reverse direction. In this manner, the light panels 402a-c and the moving light 404 may also be used to output the second notification that is indicative of the vehicle speed as described above.

Furthermore, in addition to or alternative to outputting the notifications described above via one or exterior lights or all the exterior lights 240, the processor 246 may output the first, second, third and/or the fourth notifications via one or more speakers or all the speakers 242. For example, the processor 246 may output the first notification as an audible or sound notification via one or more or all of the speakers 242a-d. Further, one or more speakers may be used to output the second, the third and/or the fourth notifications as audible or sound notifications. For example, frequency and/or pitch/volume of audible notifications output from one or more speakers may be used to indicate the vehicle speed or a rate of change of vehicle speed. Further, sound distribution across the different speakers 242a-d or delayed pattern of sound output from the speakers 242a-d may be used to indicate vehicle steering wheel rotation direction and/or angle. Furthermore, in some aspects, a shift in audible pitch/volume output from the speakers 242a-d may be used to “mimic” Doppler effect, reinforcing the perception of an approaching vehicle to the bystanders.

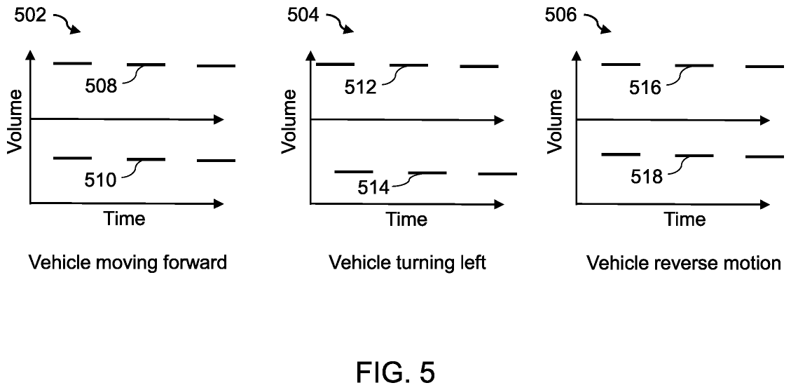

Example graphs 502, 504, 506 illustrating patterns of audio notifications output from one or more speakers, from the plurality of speakers 242, are depicted in FIG. 5. The Y-axis of each graph 502, 504, 506 depicts volume (or pitch) of audible notifications output by respective speakers, and the X-axis depicts time. In an exemplary aspect, the graph 502 depicts a pattern of first audible signals 508 output from the forward left exterior speaker 242a and a pattern of second audible signals 510 output from the forward right exterior speaker 242b when the vehicle 102 may be moving forward. In some aspects, the audible notifications may be output from the front/forward exterior speakers 242a, 242b when the vehicle movement direction may be in the forward direction.

Similarly, the graph 506 depicts a pattern of third audible signals 516 output from the rear left exterior speaker 242c and a pattern of fourth audible signals 518 output from the rear right exterior speaker 242d when the vehicle 102 may be moving in the reverse direction. In some aspects, the audible notifications may be output from the rear/back exterior speakers 242c, 242d when the vehicle movement direction may be in the reverse/backward direction.

In an exemplary aspect, when the vehicle 102 may be turning left, as depicted in the graph 504, fifth audible signals 512 output from the forward left exterior speaker 242a may have a higher pitch/volume than sixth audible signals 514 output from the forward right exterior speaker 242b. In this manner, the bystander may know that the vehicle 102 may be turning left. The processor 246 may similarly output audible notifications at different pitches/volumes via one or more speakers when the vehicle 102 may be turning right.

Although the description above describes an aspect where the processor 246 outputs notifications (e.g., the first, the second, the third and/or the fourth notifications) to inform the bystanders about vehicle's movement, in some aspects, the processor 246 may output additional notifications to assist the user 104 in conveniently controlling vehicle movement using the interface 110, as described below.

In some aspects, when the processor 246 activates the external interface movement mode and enables the user 104 to cause and/or control the vehicle movement via the interface 110, the processor 246 may obtain inputs from the vehicle sensory system 232 at a predefined frequency. For example, the processor 246 may obtain images/videos captured by the vehicle exterior cameras and/or signals from the radar and/or lidar sensors. The processor 246 may be configured to determine/detect a presence of an obstacle (e.g., a bystander) in proximity to the vehicle 102 based on the inputs obtained from the vehicle sensory system 232. The processor 246 may further determine an obstacle location relative to the vehicle 102 based on the inputs obtained from the vehicle sensory system 232. In some aspects, the processor 246 may additionally determine the presence of a bystander and/or a bystander location in proximity to the vehicle 102 by obtaining UWB and/or other wireless signals from a user device associated with the bystander.

Responsive to determining an obstacle presence (and obstacle location) in proximity to the vehicle 102, the processor 246 may determine a user location in proximity to the vehicle 102. Example methods of determining the user location in proximity to the vehicle 102 are already described above in conjunction with FIG. 1. For example, as described above, the processor 246 may determine the user location in proximity to the vehicle 102 by determining the user device location based on inputs/signals obtained from the user device 202 (e.g., UWB signals and/or via the PaaK application or RSSI values). The processor 246 may additionally determine the user location based on inputs (e.g., images/videos) obtained from the vehicle sensory system 232.

Responsive to determining the user location in proximity to the vehicle 102, the processor 246 may determine an exterior light, from the plurality of exterior lights 240, and/or a speaker, from the plurality of speakers 242, that may be closest to the user location. For example, if the user 104 may be located in proximity to a vehicle rear left side/portion (as shown in FIG. 3), the processor 246 may determine the rear left light 240c and the rear left exterior speaker 242c as being the light and the speaker that may be closest to the user location.

Responsive to determining that the rear left light 240c and the rear left exterior speaker 242c may be closest to the user location, the processor 246 may output a fifth notification via the rear left light 240c and/or the rear left exterior speaker 242c. The fifth notification may indicate to the user 104 that an obstacle may be present in proximity to the vehicle 102, and hence the user 104 should cautiously move the vehicle 102 using the interface 110. Since the fifth notification is output from an exterior light and/or a speaker that may be closest to the user 104, the user 104 may not miss hearing/viewing the fifth notification.

In some aspects, the processor 246 may cause the rear left exterior speaker 242c to audibly output a “sonar-like” blip to output the fifth notification. Further, if the rear left exterior speaker 242c is equipped to output preset messages, the processor 246 may cause the rear left exterior speaker 242c to output a preset message (that may be stored in the memory 248) indicating the obstacle presence. Furthermore, if the vehicle 102 is equipped with a microphone and may be configured to be controlled via voice commands, the user 104 may provide voice commands to the vehicle 102 to control vehicle speed, movement direction, etc., responsive to hearing the fifth notification.

In further aspects, the processor 246 may cause the rear left light 240c to flash at a predefined frequency to output the fifth notification. The frequency of light flashing and/or flashing duty cycle and/or illumination intensity may be increased or decreased based on obstacle location relative to the vehicle 102. For example, if the obstacle may be getting closer to the vehicle 102 (due to obstacle movement and/or vehicle speed/movement towards the obstacle), the frequency of light flashing, the flashing duty cycle and/or illumination intensity may be increased to alert the user 104.

In some aspects, the processor 246 may additionally output notifications via the rear left light 240c and/or the rear left exterior speaker 242c indicating the vehicle movement direction, vehicle speed, and/or the like for user's reference. The processor 246 may additionally output notifications via the rear left light 240c and/or the rear left exterior speaker 242c to indicate if the interface 110 may be faulty and/or the interface 110 may not be properly attached to the vehicle exterior surface. The processor 246 may additionally output notifications via the rear left light 240c and/or the rear left exterior speaker 242c to indicate rough, slippery or inclined surface where the vehicle 102 may be travelling, when the processor 246 identifies such surface properties based on the inputs obtained from the vehicle sensory system 232.

In further aspects, the processor 246 may implement additional measures to alert/inform the user 104 about the obstacle presence in proximity to the vehicle 102 and/or the obstacle location relative to the vehicle 102. For example, the processor 246 may transmit, via the transceiver 244, command signals to the interface 110 to cause the interface 110 to output a haptic feedback when the processor 246 detects the obstacle presence in proximity to the vehicle 102. In an exemplary aspect, when the interface 110 may be a joystick-like device, a reactive “push back” may be provided by the interface 110 to output the haptic feedback. In some aspects, the processor 246 may enable or cause the interface 110 to provide the push back with a greater force when the obstacle location may be close to the vehicle 102 (e.g., within 1-10 feet from the vehicle 102). In other aspects, a vibration element (such as an eccentric mass resonator) included in the interface 110 may be actuated, based on the command signals from the processor 246, to provide a pulse of vibration to the user's hand/palm (to provide haptic feedback to the user 104).

In additional aspects, the processor 246 may output an image or a video feed associated with the obstacle, obtained from the vehicle sensory system 232 (or an add-on external camera installed on the vehicle 102 by the user 104), via an exterior vehicle display 302 of the vehicle 102. In some aspects, the exterior vehicle display 302 may be disposed in proximity to a vehicle cargo area and may be used by the processor 246 to output the video feed associated with the obstacle when the user 104 may be located in proximity to a vehicle rear portion. The user 104 may view the video feed and may accordingly maneuver vehicle movement by using the interface 110 based on the obstacle location relative to the vehicle 102. In some aspects, the processor 246 may additionally or alternatively transmit the image/video feed to the user device 202 and/or the interface 110, via the transceiver 244 and the network 206. Responsive to receiving the image/video feed from the processor 246, the user device 202 and/or the interface 110 may output the image/video feed via respective user device display screen and/or interface display screen for user's reference.

In some aspects, the processor 246 may additionally use the exterior vehicle display 302, the user device display screen and/or the interface display screen to output tutorial videos or instructions (that may be pre-stored in the memory 248) that may assist an inexperienced user (who may using the interface 110 for the first time) in conveniently using the interface 110 and controlling the vehicle movement via the interface 110.

In further aspects, the processor 246 may be configured to control and/or restrict, via the interface 110, the vehicle movement direction, the vehicle speed and/or the vehicle steering wheel rotation angle based on the obstacle location relative to the vehicle 102, responsive to determining the obstacle presence in proximity to the vehicle 102. For example, the processor 246 may cause inertial, static and dynamic friction parameters associated with the interface 110 to change/alter such that the vehicle 102 may move slower or at a reduced speed in response to the user inputs on the interface 110, when the processor 246 detects the obstacle presence in proximity to the vehicle 102. In an exemplary aspect, a higher inertia associated with the interface 110 may make the vehicle 102 to gain speed more slowly, a higher static friction associated with the interface 110 may require more user input on the interface 110 to maintain vehicle motion/speed, and a higher viscous friction associated with the interface 110 may lower the maximum speed achieved for an equivalent user input on the interface 110. In some aspects, when the obstacle location relative to the vehicle 102 may be closer than a predefined distance threshold, the processor 246 may cause the vehicle 102 to respond to the user input on the interface 110 by moving incrementally by a small pre-determined distance, for example, one centimeter.

In additional aspects, the vehicle 102 may include a power transfer interface 304 (or a power socket) that may be configured to power one or more external equipment or tools, when the tools may be electrically coupled with the power transfer interface 304 via a wired connection or cords. The processor 246 may be configured to determine if an external equipment/tool may be connected to or plugged into the power transfer interface 304 based on the inputs obtained from the vehicle sensory system 232 (e.g., based on images/videos obtained from the vehicle cameras). Responsive to determining that an external equipment/tool may be connected to the power transfer interface 304 via a wired connection, the processor 246 may disable the external interface movement mode (if already activated) or may not enable the external interface movement mode. Furthermore, in this case, the processor 246 may output a notification, via the user device 202 or the infotainment system 238, to request the user 104 to remove the external equipment/tool from the power transfer interface 304 before enabling (or re-enabling) the external interface movement mode.

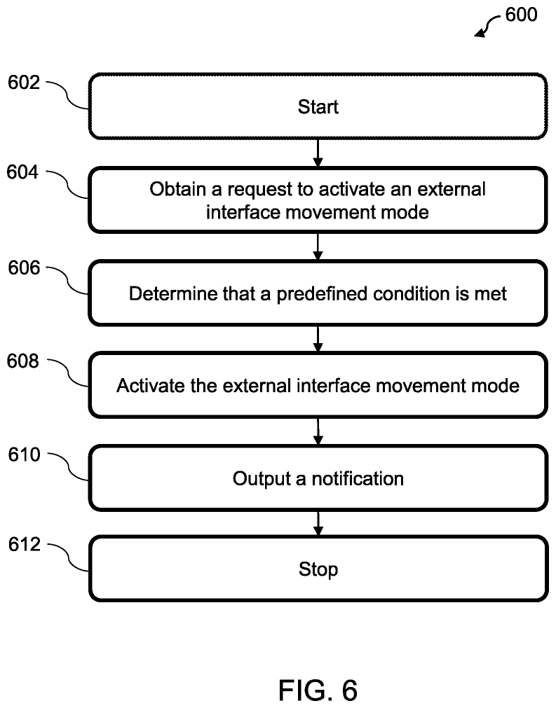

FIG. 6 depicts a flow diagram of an example notification method 600 in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include determining, by the processor 246, the request from the user 104 to activate the external interface movement mode associated with the vehicle 102 via the user device 202 or the infotainment system 238. At step 606, the method 600 may include determining, by the processor 246, that the predefined condition may be met. As described above, the processor 246 may determine that the predefined condition may be met when the user 104 may be authenticated, the user location may be located within a predefined distance (e.g., 0-8 feet) from the vehicle 102 and/or the interface 110 may be authenticated.

At step 608, the method 600 may include activating, by the processor 246, the external interface movement mode responsive to determining that the predefined condition may be met. At step 610, the method 600 may include outputting, by the processor 246, the first notification via one or more vehicle exterior lights and/or one or more vehicle speakers, responsive to activating the external interface movement mode.

The method 600 may end at step 612.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a transceiver configured to receive a request to activate an external interface movement mode associated with the vehicle to enable a vehicle movement control via an external interface, wherein the external interface is configured to be removably attached to a vehicle exterior surface; and
a processor communicatively coupled with the transceiver, wherein the processor is configured to:
obtain the request from the transceiver;
determine that a predefined condition is met responsive to obtaining the request;
activate the external interface movement mode responsive to determining that the predefined condition is met; and
output a first notification responsive to activating the external interface movement mode.

2. The vehicle of claim 1, wherein the transceiver receives the request from a user via a user device or a vehicle Human-Machine Interface (HMI).

3. The vehicle of claim 2, wherein the processor is further configured to:
authenticate the user responsive to obtain the request; and
determine that the predefined condition is met when the user is authenticated.

4. The vehicle of claim 2, wherein the processor is further configured to:
determine a user location in proximity to the vehicle; and
determine that the predefined condition is met when the user location is within a predefined distance from the vehicle.

5. The vehicle of claim 1 further comprising one or more vehicle exterior lights and one or more vehicle speakers.

6. The vehicle of claim 5, wherein the processor outputs the first notification by illuminating the one or more vehicle exterior lights in a first predefined pattern.

7. The vehicle of claim 5, wherein the processor is further configured to:
obtain command signals from the external interface responsive to activating the external interface movement mode, wherein the command signals are associated with user inputs received on the external interface; and
control a vehicle movement direction, a vehicle speed and a vehicle steering wheel rotation angle based on the command signals.

8. The vehicle of claim 7, wherein the processor is further configured to output a second notification by illuminating the one or more vehicle exterior lights in a second predefined pattern, wherein the second notification is indicative of the vehicle speed.

9. The vehicle of claim 8, wherein the processor is further configured to output a third notification by illuminating the one or more vehicle exterior lights in a third predefined pattern, wherein the third notification is indicative of the vehicle steering wheel rotation angle.

10. The vehicle of claim 9, wherein the processor is further configured to output a fourth notification by illuminating the one or more vehicle exterior lights in a fourth predefined pattern, wherein the fourth notification is indicative of the vehicle movement direction.

11. The vehicle of claim 10, wherein the processor is further configured to output at least one of the first notification, the second notification, the third notification and the fourth notification via the one or more vehicle speakers.

12. The vehicle of claim 5 further comprising a vehicle sensor unit configured to detect an obstacle presence in proximity to the vehicle, wherein the processor is further configured to:
obtain inputs from the vehicle sensor unit responsive to activating the external interface movement mode;
determine the obstacle presence in proximity to the vehicle based on the inputs;
determine a vehicle exterior light from the one or more vehicle exterior lights or a vehicle speaker from the one or more vehicle speakers that is closest to a user location, responsive to determining the obstacle presence; and
output a fifth notification indicating the obstacle presence via the vehicle exterior light or the vehicle speaker.

13. The vehicle of claim 12, wherein the processor is further configured to control at least one of a vehicle movement direction, a vehicle speed and a vehicle steering wheel rotation angle based on an obstacle location in proximity to the vehicle, responsive to determining the obstacle presence.

14. The vehicle of claim 12, wherein the vehicle sensor unit comprises one or more vehicle exterior cameras configured to capture images or videos of a geographical area in proximity to the vehicle.

15. The vehicle of claim 14 further comprising an exterior vehicle display, wherein the processor is configured to:
obtain the images or videos from the one or more vehicle exterior cameras; and
output the images or videos via the exterior vehicle display or an external interface display.

16. The vehicle of claim 1 further comprising a power transfer interface, wherein the processor is further configured to:
determine that an external equipment is connected via a wired connection to the power transfer interface; and
disable the external interface movement mode responsive to determining that the external equipment is connected via the wired connection to the power transfer interface.

17. A notification method comprising:
obtaining, by a processor, a request to activate an external interface movement mode associated with a vehicle to enable a vehicle movement control via an external interface, wherein the external interface is configured to be removably attached to a vehicle exterior surface;
determining, by the processor, that a predefined condition is met responsive to obtaining the request;
activating, by the processor, the external interface movement mode responsive to determining that the predefined condition is met; and
outputting, by the processor, a notification responsive to activating the external interface movement mode.

18. The method of claim 17, wherein obtaining the request comprises obtaining the request from a user via a user device or a vehicle Human-Machine Interface (HMI).

19. The method of claim 18 further comprising:
determining a user location in proximity to the vehicle; and
determining that the predefined condition is met when the user location is within a predefined distance from the vehicle.

20. A non-transitory computer-readable storage medium having instructions stored thereupon which, when executed by a processor, cause the processor to:
obtain a request to activate an external interface movement mode associated with a vehicle to enable a vehicle movement control via an external interface, wherein the external interface is configured to be removably attached to a vehicle exterior surface;
determine that a predefined condition is met responsive to obtaining the request;
activate the external interface movement mode responsive to determining that the predefined condition is met; and
output a notification responsive to activating the external interface movement mode.
